(19) United States
(12) Patent Application Publication
(10) Pub. No.: US 2026/0081786 A1
(43) Pub. Date: Mar. 19, 2026

(54) EVALUATING SOURCE CONTRIBUTION TO GENERATED CONTENT

(71) Applicant: International Business Machines Corporation, Armonk, NY (US)

(72) Inventors: Hirenkumar Ashokbhai Thummar, SANTA CLARA, CA (US); Alfredo Alba, Morgan Hill, CA (US); Daniel Gruhl, San Jose, CA (US); Shubhi Asthana, San Jose, CA (US); Linda Ha Kato, San Jose, CA (US); Bing Zhang, San Jose, CA (US); Steven R. Welch, Gilroy, CA (US)

(21) Appl. No.: 18/889,444

(22) Filed: Sep. 19, 2024

(51) Int. Cl. H04L 9/32

(52) U.S. Cl. CPC H04L 9/3247; H04L 9/3236; H04L 2209/605

(57) ABSTRACT

Evaluating the presence of training data in generated content by defining a first signature of a portion of the generated content by loading the generated content into memory registers, dividing the generated content into tokens, designating a sequential group of tokens as a signature shingle, and defining the first signature as a hash function value for the signature shingle. The evaluation also including matching the first signature to a training data signature in a training data signature database, updating a database record for the generated content to include the training data associated with the training data signature, and providing an output comprising data associated with the training data signature over a network.

### FIELD OF THE INVENTION

The disclosure relates generally to the automated generation of content by machine learning models. The disclosure relates particularly to evaluating the presence of training data in generated content.

### BACKGROUND

Large Language Models may have billions of parameters derived from trillions of training tokens. Such models may be used to generate content in response to user provided prompting. Content generated using such models may include one or more of the training tokens.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the evaluation of generated content for the presence of training data.

Aspects of the invention disclose methods, systems and computer readable media associated with evaluating the presence of training data in generated content by generating content in response to a user prompt received over a network. defining a first signature of a portion of the generated content by loading the generated content into memory registers, dividing the generated content into tokens, designating a sequential group of tokens as a signature shingle, defining the first signature as a hash function value for the signature shingle, and storing the first signature in persistent storage of the system. The evaluation also including matching the first signature to a training data signature in a training data signature database, updating a database record for the generated content to include the training data associated with the training data signature, storing the updates database record for the generated content, and providing an output comprising data associated with the training data signature to the user over the network.

Aspect of the invention include systems, methods and computer products for evaluating the presence of training data in generated content, including by receiving a database comprising training data signatures over a network, defining a first signature of a portion of the generated content, matching the first signature to a training data signature in the training data signature database, updating a database record for the generated content to include the training data associated with the training data signature, and providing an output comprising data associated with the training data signature, over the network.

Aspect of the invention include systems, methods and computer products for evaluating the presence of training data in generated content by: receiving a database comprising training data over a network, determining a training data signature, appending the training data signature to a training data database record, defining a first signature of a portion of the generated content, matching the first signature to the training data signature in the training data signature database, updating a database record for the generated content to include the training data associated with the training data signature, and providing an output comprising data associated with the training data signature over a network.

Aspects further include the database including training data copyright status. Further embodiments include the database containing source attribution for training data, wherein the output further comprises the source attribution of the training data.

Aspect include the output also including a copyright status of the training data as well as the methods including steps of determining a density of training data in the generated content, and determining a content compliance status for the generated content according to the density.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

With the advent of Large Language Models with parameters in the billions and training tokens in the trillions, understanding whether the generated/predicted text from the model infringes on the intellectual property or copyright from the sources of the tokens used for training becomes imperative. The success of any generative system implementation depends upon compliance with copyright and intellectual property laws. Being compliant with local and international laws, regulations, and policies avoids costly law suits and litigation originated from the rightful owners of the materials and works being rendered by the AI generative models. Disclosed embodiments provide an evaluation of the presence of training data in generated content and an indication of any copyright protection of that training data.

Embodiments include a system that uses signatures from the original copyrighted/intellectual property works and is capable of detecting how much of the original content is present in the model generated text. Furthermore, the systems provide the ability to identify how many of such signatures are present in more than one of the copyrighted materials used for model training. This provides a measure for generative text compliance based on the rules and policy. For instance, in music there are a maximum amount of bars that can be used without infringement. While there is no set rule on how much text can be used without infringement, the system provides the ability to measure the density of the copyrighted text within the model generated text.

In one embodiment, methods, systems and computer program products for evaluating the presence of training data in generated content include defining a first signature of a portion of the generated content by loading the generated content into memory registers, dividing the generated content into tokens, designating a sequential group of tokens as a signature shingle, and defining the first signature as a hash function value for the signature shingle. The evaluation also including matching the first signature to a training data signature in a training data signature database, updating a database record for the generated content to include the training data associated with the training data signature, and providing an output comprising data associated with the training data signature over a network. Such a method provides a user with generated content as well as additional outputs including an indication of training data present in the generated content. In this embodiment, such training data may additionally be identified as copyrighted material and source attribution for the copyrighted training data may also be provided. Suh methods enable users to identify the presence of copyrighted content in the generated output of a model and to take appropriate steps when such content is part of the generated output.

Embodiments of the invention include systems, methods and computer products for evaluating the presence of training data in generated content, including by receiving a database comprising training data signatures over a network, defining a first signature of a portion of the generated content, matching the first signature to a training data signature in the training data signature database, updating a database record for the generated content to include the training data associated with the training data signature, and providing an output comprising data associated with the training data signature, over the network. Such a method provides a user with generated content as well as additional outputs including an indication of training data present in the generated content. In this embodiment, such training data may additionally be identified as copyrighted material and source attribution for the copyrighted training data may also be provided. Suh methods enable users to identify the presence of copyrighted content in the generated output of a model and to take appropriate steps when such content is part of the generated output.

In one embodiment, a method for evaluating the presence of training data in generated content includes: receiving a database comprising training data over a network, determining a training data signature, appending the training data signature to a training data database record, defining a first signature of a portion of the generated content, matching the first signature to the training data signature in the training data signature database, updating a database record for the generated content to include the training data associated with the training data signature, and providing an output comprising data associated with the training data signature over a network. Such a method provides a user with generated content as well as additional outputs including an indication of training data present in the generated content. In this embodiment, such training data may additionally be identified as copyrighted material and source attribution for the copyrighted training data may also be provided. Suh methods enable users to identify the presence of copyrighted content in the generated output of a model and to take appropriate steps when such content is part of the generated output.

Aspects further include the database including training data copyright status. These embodiments provide the advantage of enabling identification of copyrighted training data in generated content. Further embodiments include the database containing source attribution for training data, wherein the output further comprises the source attribution of the training data. These embodiments provide the advantage of enabling source attribution for generated content.

Aspect include the output also including a copyright status of the training data associated with the generated content, enabling association of the generated content with copyrighted training data, as well as the methods including steps of determining a density of training data in the generated content, and determining a content compliance status for the generated content according to the density, providing users an indication of intellectual property compliance for the generated content.

Aspects of the present invention relate generally to content generating systems and, more particularly, to LLM generative AI systems. In embodiments, a content generating system proceeds by generating content in response to a user prompt received over a network, defining a first signature of a portion of the generated content by: loading the generated content into memory registers; dividing the generated content into tokens; designating a sequential group of tokens as a signature shingle; defining the first signature as a hash function value for the signature shingle; and storing the first signature in persistent storage, matching the first signature to a training data signature in a training data signature database, updating a database record for the generated content to include the training data associated with the training data signature, storing the updated database record in persistent storage, and providing an output comprising data associated with the training data signature over the network. Such systems enable users to determine the provenance of generated content and to ensure compliance with norms and statutes.

In accordance with aspects of the invention there is a method for automatically evaluating the presence of training data in content generated by a system or method capable of generating content in response to a user prompt, the method includes: generating content in response to a user prompt received over a network, defining a first signature of a portion of the generated content by: loading the generated content into memory registers; dividing the generated content into tokens; designating a sequential group of tokens as a signature shingle; defining the first signature as a hash function value for the signature shingle; and storing the first signature in persistent storage, matching the first signature to a training data signature in a training data signature database, updating a database record for the generated content to include the training data associated with the training data signature, storing the updated database record in persistent storage, and providing an output comprising data associated with the training data signature over the network. Such methods enable users to determine the provenance of generated content and to ensure compliance with norms and statutes.

Aspects of the invention provide an improvement in the technical field of generative artificial intelligence systems. Content generating systems may not provide any indication of the presence of training data in the generated output, let alone any indication of a copyright status of such training data. In many cases, users do not have any indication as to the presence of copyrighted data in the generated output. As a result, user confidence that generated content is copyright compliant may be low or nonexistent. Implementations of the invention leverage the availability of annotated training data to provide an indication of the presence and status of training data in generated content. This provides the improvement of providing generated content together with an indication that the content is free of any copyright or other content derived issues.

Aspects of the invention also provide an improvement to computer functionality. In particular, implementations of the invention are directed to a specific improvement to the way content generation systems operate, embodied in the evaluation of training data and generated content. In embodiments, the system and method proceeds by generating content in response to a user prompt received over a network, defining a first signature of a portion of the generated content by: loading the generated content into memory registers; dividing the generated content into tokens; designating a sequential group of tokens as a signature shingle; defining the first signature as a hash function value for the signature shingle; and storing the first signature in persistent storage, matching the first signature to a training data signature in a training data signature database, updating a database record for the generated content to include the training data associated with the training data signature, storing the updated database record in persistent storage, and providing an output comprising data associated with the training data signature over the network. Such systems enable users to request and receive generated content together with a dependable indication as to the copyright compliance of the received content.

As an overview, a generative AI system is an artificial intelligence application executed on data processing hardware that generates content pertaining to a given subject-matter domain in response to a user prompt. The generative AI system receives prompts from users over a network and generates content according to the training of the associated large language model. The model may be trained using a corpus of documents. The documents may include any file, text, article, or source of data for use in training the generative AI system. The documents may include copyright status and source attribution data. Depending upon the training and the specific details of a user prompt, portions of the training data may be present in the generated content. An output may be provided which includes the generated content together with an indication of which portions, if any, of the generated content are training data, as well as the copyright and attribution data for any such training data.

In an embodiment, one or more components of the system can employ hardware and/or software to solve problems that are highly technical in nature (e.g., generating content in response to a user prompt received over a network, defining a first signature of a portion of the generated content by: loading the generated content into memory registers; dividing the generated content into tokens; designating a sequential group of tokens as a signature shingle; defining the first signature as a hash function value for the signature shingle; and storing the first signature in persistent storage, matching the first signature to a training data signature in a training data signature database, updating a database record for the generated content to include the training data associated with the training data signature, storing the updated database record in persistent storage, providing an output comprising data associated with the training data signature over the network, etc., Such systems enable users to determine the provenance of generated content and to ensure compliance with norms and statutes. These solutions are not abstract and cannot be performed as a set of mental acts by a human due to the processing capabilities needed to facilitate compliant content generation. Further, some of the processes performed may be performed by a specialized computer for carrying out defined tasks related to remote content generation. For example, a specialized computer can be employed to carry out tasks related to compliant content generation, or the like.

In one embodiment, a method for evaluating the presence of training data in generated content includes training a generative content model. Training includes modifying a set of network node weights according to the specific details of training data portions. A database of training data may be provided over a network. The database may include copyrighted content licensed from the copyright holders. In addition to training the model, methods may determine signature hash values for training data portions which may include copyrighted content. In one embodiment, methods apply a tokenization process to the training data, defining portions of the data as a series of discrete tokens. Following tokenization, methods separate the series of tokens into a series of shingles, each shingle having a uniform token length. Methods then apply a hash function, such as xxh3_64, to each shingle yielding a signature hash value for each shingle. The hash values are appended to a training data signature database record which includes the shingle and any copyright or source attribution data associated with the shingle.

In one embodiment, a computer implemented method for evaluating the presence of training data in generated content includes generating content in response to a user prompt received over a network. In this embodiment, the prompt may include task background, task instructions, and specifications for the desired output of the task. In response to the prompt, a trained generative artificial intelligence, large language model may generate the desired content. After generating the content, the method defines and determines one or more digital signatures from the generated content/The method proceeds by defining a first signature of a portion of the generated content. In this embodiment, the method loads the generated content into memory registers. The method then tokenizes the generated content using a natural language toolkit. The tokenization divides the generated content into a series of discrete tokens. Following the tokenization, the method divides the series of tokens into signature shingles, each signature shingle including a defined number of tokens—the token length of the shingle. All shingles have the same token length.

In one embodiment, the method sets the token length for the signature shingles of the generated content equal to the token length used for generating signature shingles for training data content and provided copyrighted material content. After defining shingles using the token length, the method determines a hash value, such as a xxh3_64, hash value for each defined shingle. In one embodiment, other hash functions besides xxh3_64, may be used by methods for determining shingle signature hash values. In one embodiment, the method stores the hash function for each shingle in persistent storage.

In one embodiment, systems and methods match the generated content signature hash value for each generated content shingle to the hash values stored in the training data signature hash value database. Matching hash values indicates that the generated content matches the training data associated with the matching training data signature hash value that matches the current generated content signature hash value. In this embodiment, the method updates a generated content database record for the generated content shingle, adding the copyright and source attribution data associated with the training data and matching generated data to the database record. Methods then store the updated generated content database record for the shingle in persistent storage.

In one embodiment, systems and methods provide an output over the network to a user in response to the user's prompt. The output includes the generated content to the user. When methods find that portions of the generated data match copyrighted content, the output includes an indication of the relevant generated content as well as the copyright status data for that portion and any associated source attribution data for the portion. In one embodiment, systems and methods store a record of the prompt, the generated content output provided, the copyright status, the associated user as well as data and time data for the output.

In one embodiment, outputs include an indication of copyright compliance for the generated content. For example, the copyright compliance may indicate that no copyrighted content was found in the generated content or provide an indication of which particular portion of the generated content is protected by copyright as well as any additional details regarding the identity of the copyright holder for that content, discerned from the source attribution data associated with the relevant training data portion. Access to accurate copyright status and to source attribution data enables a user to evaluate the appropriateness of the generated content and to determine how to proceed with using or discarding the content.

In one embodiment, systems and methods determine a training material, or copyright, density for the generated content. In this embodiment, the method evaluates the shingles of the generated content and determines which shingles match training data shingles, and further, which shingles match copyrighted training data shingles. In this embodiment, methods and systems also determine an overall number of shingles for the generated content and then determine a training or copyrighted density as the ratio of the training shingles, or copyrighted training shingles, to the total number of shingles for the generated content. In this embodiment, systems and methods utilize a compliance framework to evaluate the copyright density and the extent to which generated content signatures overlap with copyrighted training data signatures to identify generated content as either compliant or non-compliant with copyright laws. In this embodiment, systems and methods embody copyright laws as rules for evaluating the density and signature overlap.

In one embodiment, a simple exemplar of the compliance framework includes: a system and method that compute the shingles according to the specification of training content that is being consumed by a preprocessing pipeline. The system and method look up the computed shingles in the content owner provided shingles database. The system and method evaluate the count of the shingles from the document being preprocessed found in the content owners shingles database using a rules engine. The rules engine having been configured with the desired overlap thresholds for training content. According to the output of the rules engine, the system and method let the processing of the training document proceed if the overlap is less than then prescribed threshold, or drops the training document from the pre-processing pipeline if the overlap exceeds the prescribed threshold. Training proceeds using the allowed training documents compliant with the prescribed policy and threshold.

In one embodiment, systems and methods provide the match density together with the generated output as an indication of the extent to which the generated content includes verbatim portions of the training data. In this embodiment, the method highlights, emboldens, underlines, or otherwise differentiates those shingles of the generated output which match shingles of the training data. This output enables the prompt engineer/user, to modify their submitted prompt to achieve a greater or lesser match density in the generated content.

In one embodiment, systems and methods evaluate generated music scores for the presence of music from copyrighted training data music compositions. In this embodiment, systems and methods determine signatures for portions of the generated content and match those signatures against signatures previously determined for portions of copyrighted training data. Systems and methods may compare signatures for the entire generated composition to signatures for entire training data compositions, but also compare signatures for portions of each of the respective compositions and determine a density of matched signatures to overall signature numbers for the generated composition. In this embodiment, the method then includes in its output an indication of the density, or the extent to which copyrighted compositions portions contribute to the generated content.

In one embodiment, systems and methods aid prompt engineers by providing copyright compliance status information with the generated content. This enables the engineers to identify problematic generated content and to shape the prompts to avoid generating copyright infringing content.

Businesses can harness the power of AI-generated content without the legal risks associated with intellectual property infringement by ensuring compliance with copyright laws while utilizing Large Language Models (LLMs). In one embodiment, the LLM comprises a transformer deep learning model trained on corpora composed of licensed and proprietary contents. In the transformer model, every output is connected to every input, and weightings between elements are calculated based upon connections between inputs and outputs. Disclosed embodiments provide copyright status information along with the generated content enabling businesses to select generated content which is free of any copyright derived issues.

In the publishing and media sectors, disclosed system provides a safeguard against unintentional copyright infringements. Publishers, content creators, and media companies can use LLMs to generate creative content, confident that the output is vetted for copyright compliance. Disclosed embodiments provide copyright status information along with the generated content enabling businesses to select generated content which is free of any copyright derived issues. This reduces legal risks and fosters trust in AI-generated content.

For the music and entertainment industry, disclosed systems and methods can be used to analyze generated content such as lyrics or script drafts to ensure the generated content does not inadvertently use copyrighted elements from existing works. Disclosed embodiments provide copyright status information along with the generated content enabling businesses to select generated content which is free of any copyright derived issues. This capability is crucial in an industry where copyright disputes are common and can be financially and reputationally damaging.

Disclosed systems and methods can ensure that the LLM generated academic content or study materials of researchers and educators in academic settings do not violate copyright norms, by providing accurate indications that generated content is free of copyright issues. This is especially beneficial in an era where digital learning tools and AI-assisted education are becoming increasingly prevalent.

Disclosed systems and methods enable entities with legal and compliance departments to oversee their content creation processes, ensuring all generated materials are within legal bounds. Particularly marketing and public relations content, where brand integrity and compliance are paramount.

Disclosed systems and methods offer a competitive edge for firms specializing in AI and technology. It allows these companies to offer enhanced, legally compliant LLM services to clients, thereby expanding their market reach while adhering to intellectual property laws.

Start-ups and Innovators: Emerging businesses and start-ups in the tech sector can leverage disclosed systems and methods to ensure their innovative uses of LLMs are legally sound. This compliance assurance can be a critical factor in attracting investments and establishing credibility in the market.

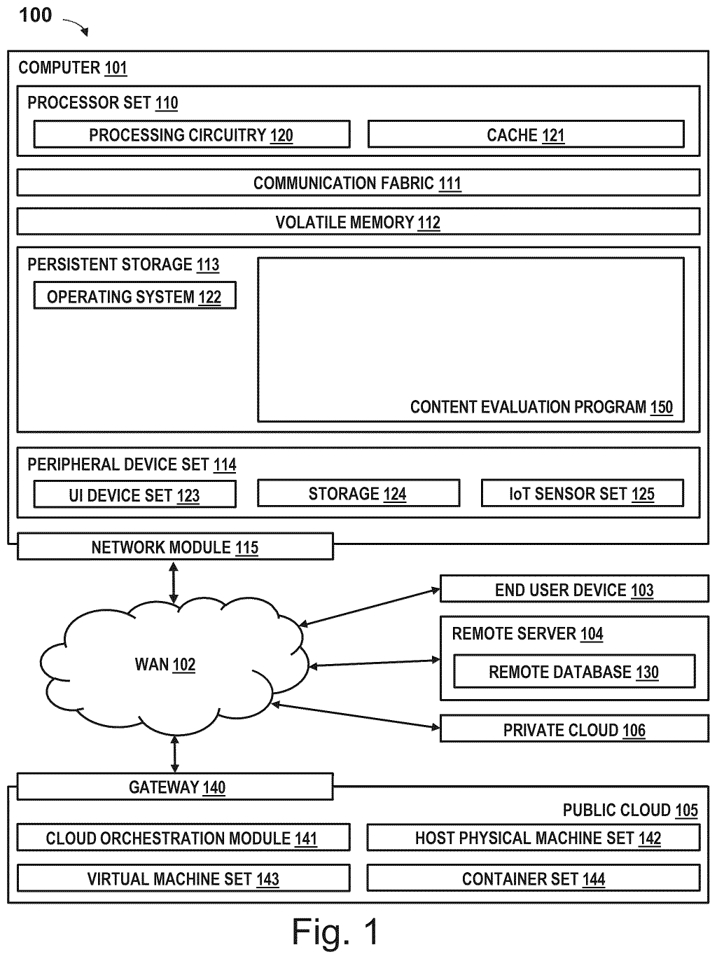

As shown in FIG. 1, computing environment 100 contains an example of an environment for the execution of at least some of the computer code involved in performing the inventive methods, such as content evaluation program block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

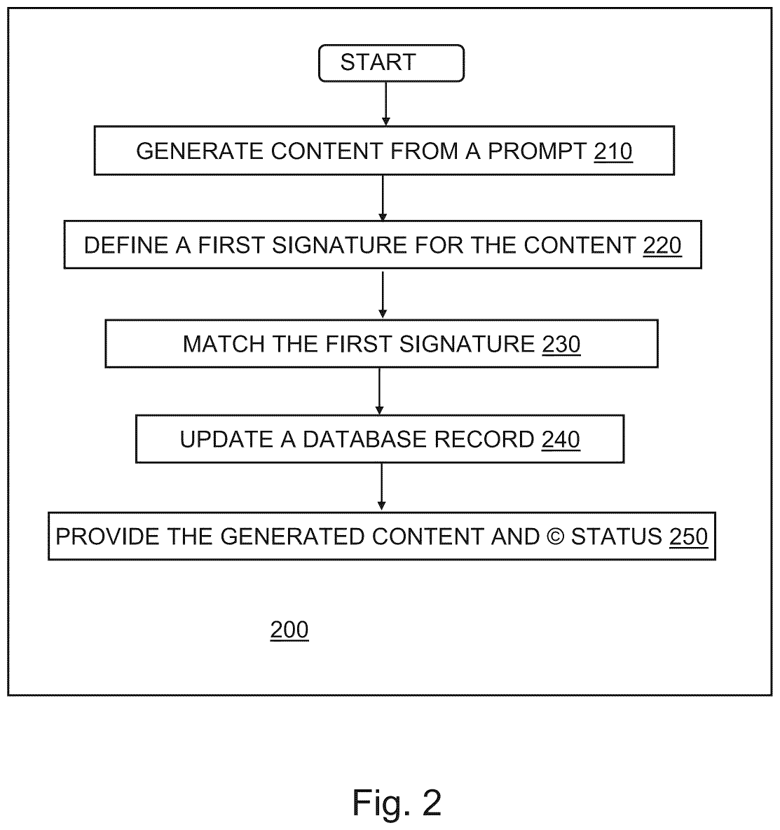

FIG. 2 provides a flowchart 200, illustrating exemplary activities associated with the practice of the disclosure. After program start, at step 210, content evaluation program 150, receives a user prompt and generates content using a trained large language model. In one embodiment, program 150 receives the prompt over a communications network 102.

At step 220, program 150 defines a first signature for the generated content. The method loads the generated content into memory, performs a tokenization step on the generated content, dividing the content into a series of tokens. The method then divides the series of tokens into a series of shingles, each shingle having a defined token length. In one embodiment, the token length has a correlation to the token length of content of interest, such as training data which is copyright protected, or a portion of training data, such as a defined number of musical measures or ‘bars’ from copyright protected music compositions of the training data. In this way the generated content is redefined as the series of signature shingles.

The method then determines a hash value, such as xxh3_64, or xxh3_128, or other hash function value, using the content of each respective single as the input for the selected hash function. The method then stores the input shingle and output hash value together. This steps yields a set of signature hash function values, one hash function value for each of the signature shingles of the generated content. In one embodiment, the method stores the shingles and signature shingle hash values together in a generated content signature database.

In one embodiment, the training data of the current version of the model may be similarly transformed into a set of signature hash function values, using an identical tokenization process and token length for dividing the tokens of the training data into shingles. The method stores the signature shingle hash function values of the training data in a training data signature database.

At step 230, the content evaluation program 150 matches each signature shingle hash function result for the generated data to the training data signature database to identify records in the training data signature database having an identical signature shingle hash function value.

In one embodiment, at step 240, the method updates a database record in the training data signature database and/or the generated content signature database reflecting the match between the two hash values, and associating any copyright status and source attribution data for the shingle of the training data record with the generated content shingle. The method stores the updated records in the respective databases.

In an embodiment, at step 250, the method then provides the generated content as an output to the user. The output may also include the prompt, the model version number, and the copyright and source attribution data associated with the matched training data shingle signature and now with the generated content shingle signature.

In one embodiment, in an optional step, the method determines a copyrighted match density for the generated content. In this embodiment, the method determines the copyrighted match density as a ratio of the number of generated content shingles matched to copyrighted training data shingles, and the total number of generated content shingles. In this embodiment, the method utilizes the determined copyrighted match density in determining a compliance status for the generated content. In one embodiment, the method classifies generated content having a positive copyrighted match density, indicating that at least one shingle of the generated content matched to a copyrighted training data shingle, indicating the inclusion of copyrighted content in the generated content.

In one embodiment, the method determines training data signatures using a smaller value for token length. Whereas a token length may be utilized which correlates to an entire copyrighted work, in this embodiment, a shorter token length, correlated to a single sentence or a single paragraph may be used. The method stores the training data shingle and signature hash values for those shingles together in a training data signature database. In this embodiment, the method uses the same token length in determining the generated content shingles and then the generated content signature hash values for those shingles. The method stores the generated content shingles and signature hash values in a generated content signature database. The method then cross-checks the two databases for matches between respective hash values. In this embodiment, the method determines a density as a ratio of matched shingle hash values to total shingle hash values for the generated content. In this embodiment, the method provides the match density together with the generated output as an indication of the extent to which the generated content includes verbatim portions of the training data. In this embodiment, the method highlights, emboldens, underlines, or otherwise differentiates those shingles of the generated output which match shingles of the training data. This output enables the prompt engineer/user, to modify their submitted prompt to achieve a greater or lesser match density in the generated content.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, or media, as those terms are used in the present disclosure, explicitly excludes storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage medium or device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for evaluating a presence of training data in generated content, the method comprising:
generating content in response to a user prompt received over a network;
defining a first signature of a portion of the generated content by:
loading the generated content into memory registers;
dividing the generated content into tokens;
designating a sequential group of tokens as a signature shingle;
defining the first signature as a hash function value for the signature shingle; and
storing the first signature in persistent storage;
matching the first signature to a training data signature in a training data signature database;
updating a database record for the generated content to include the training data associated with the training data signature;
storing the updated database record in persistent storage; and
providing an output comprising data associated with the training data signature over the network.

2. The computer implemented method according to claim 1, wherein the output further comprises a copyright status of the training data.

3. The computer implemented method according to claim 1, wherein the training data comprises a plurality of training data portions.

4. The computer implemented method according to claim 3, further comprising determining a content compliance status for the generated content according to the plurality of training data portions.

5. The computer implemented method according to claim 1, further comprising:
determining a density of training data in the generated content; and
determining a content compliance status for the generated content according to the density.

6. A computer implemented method for evaluating a presence of training data in generated content, the method comprising:
receiving a training data signature database over a network,
defining a first signature of a portion of the generated content;
matching the first signature to a training data signature in the training data signature database;
updating a database record for the generated content to include training data associated with the training data signature; and
providing an output comprising data associated with the training data signature, over the network.

7. The computer implemented method according to claim 6, wherein the training data signature database further comprises training data copyright status.

8. The computer implemented method according to claim 6, wherein the output further comprises source attribution.

9. The computer implemented method according to claim 6, wherein the output further comprises a copyright status.

10. The method according to claim 6, further comprising:
determining a density of training data in the generated content; and
determining a content compliance status for the generated content according to the density.

11. A computer implemented method for evaluating a presence of training data in generated content, the method comprising:
receiving a training data signature database over a network;
determining a training data signature;
appending the training data signature to a training data database record;
defining a first signature of a portion of the generated content;
matching the first signature to the training data signature in the training data signature database;
updating a database record for the generated content to include training data associated with the training data signature; and
providing an output comprising data associated with the training data signature over the network.

12. The computer implemented method according to claim 11, wherein the training data signature database further comprises a training data copyright status.

13. The computer implemented method according to claim 11, wherein the output further comprises source attribution data.

14. The computer implemented method according to claim 11, wherein the output further comprises a copyright status.

15. The method according to claim 11, further comprising:
determining a density of training data in the generated content; and
determining a content compliance status for the generated content according to the density.

16. A computer program product for evaluating a presence of training data in generated content, the computer program product comprising one or more computer readable storage media and collectively stored program instructions on the one or more computer readable storage media, the stored program instructions which, when executed, cause one or more computer processors to perform a method comprising:
defining a first signature of a portion of the generated content by:
loading the generated content into memory registers;
dividing the generated content into tokens;
designating a sequential group of tokens as a signature shingle; and
defining the first signature as a hash function value for the signature shingle;
matching the first signature to a training data signature in a training data signature database;
updating a database record for the generated content to include the training data associated with the training data signature; and
providing an output comprising data associated with the training data signature over a network.

17. The computer program product according to claim 16, wherein the output further comprises a copyright status of the training data.

18. The computer program product according to claim 16, wherein the training data comprises a plurality of training data portions.

19. The computer program product according to claim 18, the method further comprising determining a content compliance status for the generated content according to the plurality of training data portions.

20. The computer program product according to claim 16, further comprising:
determining a density of training data in the generated content; and
determining a content compliance status for the generated content according to the density.

21. A computer system for evaluating a presence of training data in generated content, the system comprising:
one or more computer processors;
one or more computer readable storage media; and stored program instructions on the one or more computer readable storage media for execution by the one or more computer processors, the stored program instructions which, when executed, cause the one or more computer processors to perform a method comprising:
defining a first signature of a portion of the generated content by:
loading the generated content into memory registers;
dividing the generated content into tokens;
designating a sequential group of tokens as a signature shingle; and
defining the first signature as a hash function value for the signature shingle;
matching the first signature to a training data signature in a training data signature database;
updating a database record for the generated content to include the training data associated with the training data signature; and
providing an output comprising data associated with the training data signature over a network.

22. The computer system according to claim 21, wherein the output further comprises a copyright status of the training data.

23. The computer system according to claim 21, wherein the training data comprises a plurality of training data portions.

24. The computer system according to claim 23, the method further comprising determining a content compliance status for the generated content according to the plurality of training data portions.

25. The computer system according to claim 21, further comprising:
determining a density of training data in the generated content; and
determining a content compliance status for the generated content according to the density.
